(19) United States
(12) Patent Application Publication
(10) Pub. No.: US 2018/0174725 A1
(43) Pub. Date: Jun. 21, 2018

(54) COIL WINDNG

(71) Applicant: DELTA ELECTRONICS, INC., Taoyuan City (TW)

(72) Inventors: Yi-Fan Wu, Taoyuan City (TW); Yi-Lin Chen, Taoyuan City (TW); Ching-Hsiang Tien, Taoyuan City (TW); Gang Wang, Taoyuan City (TW); Kao-Tsai Liao, Taoyuan City (TW); Hua-Sheng Lin, Taoyuan City (TW)

(21) Appl. No.: 15/723,781

(22) Filed: Oct. 3, 2017

(30) Foreign Application Priority Data
Dec. 20, 2016 (CN) 201621404305.X

(51) Int. Cl. H01F 5/04

(52) U.S. Cl. CPC H01F 5/04

(57) ABSTRACT

A coil winding includes a coil. The coil has a first winding segment and a second winding segment. The first winding segment includes a first lead. The second winding segment includes a second lead. The first winding segment is stacked as a first winding portion, and the first lead is connected with the first winding portion. The second winding segment is arranged along a lateral direction as a second winding portion, further arranged on the second winding portion along a lateral direction as a third winding portion, and further arranged on the third winding portion along a lateral direction as a fourth winding portion, and the second lead is connected with the fourth winding portion. Therefore, the space where the first lead located at is directly and sufficiently used, none of any extra space is occupied, hence the space can be effectively utilized.

### FIELD OF THE INVENTION

The present invention relates to a coil, and more particularly to a coil winding with improved space utilization.

### BACKGROUND OF THE INVENTION

In the magnetic assembly product of prior art, such as a transformer or an inductor, various types of coil windings are applied to meet the practical demands.

Please refer to FIG. 1, FIG. 2 and FIG. 3. FIG. 1 schematically illustrates the sectional view of a conventional coil winding and the winding directions thereof of prior art. FIG. 2 schematically illustrates a view showing the conventional coil winding of prior art. FIG. 3 schematically illustrates another view showing the conventional coil winding shown in FIG. 2. In the prior art, a conventional coil winding 1 usually has a first lead 11, a winding segment 12 and a second lead 13. In the conventional coil winding 1, the winding segment 12 is continuously arranged, and two ends of the winding segment 12 are respectively connected with the first lead 11 and the second lead 13.

However, by this manner of prior art, since the winding segment 12 is wound by starting from the inner side, that is the junction of the first lead 11 and the winding segment 12, some of the available winding space is occupied by the diameter of the first lead 11 itself. For example, at least a width space of the first lead's diameter is occupied. If an angle of the first lead 11 extending out from the winding is large, width space of more than one diameter of the first lead 11 will be occupied.

Therefore, there is a need to provide an improved coil winding.

### SUMMARY OF THE INVENTION

In accordance with an aspect of the present invention, there is provided a coil winding. The coil winding includes a coil. The coil has a first winding segment and a second winding segment. The first winding segment includes a first lead. The second winding segment includes a second lead. The first winding segment is arranged from an outer concentric of the coil to an inner concentric of the coil along an inward direction as a first winding portion, and the first lead is connected with the first winding portion. The second winding segment is arranged along lateral direction as a second winding portion, overlapping on the second winding portion along an opposite lateral direction as a third winding portion, and further arranged overlapping on the third winding portion along the lateral direction as a fourth winding portion, and the second lead is connected with the fourth winding portion.

In accordance with another aspect of the present invention, there is provided a coil winding. The coil winding includes a coil. The coil has a first winding segment and a second winding segment. The first winding segment includes a first lead. The second winding segment includes a second lead. The first winding segment is stacked along a first direction as a first winding portion, and the first lead is connected with the first winding portion. The second winding segment is arranged along a second direction as a second winding portion, further arranged along a third direction as a third winding portion, and further arranged along the second direction as a fourth winding portion, and wherein the second, third and fourth winding portions are stacked, and the second lead is connected with the fourth winding portion.

In accordance with a further aspect of the present invention, there is provided a coil winding. The coil winding includes a coil. The coil has a first winding segment and a second winding segment. The first winding segment includes a first lead. The second winding segment includes a second lead. The first winding segment is stacked along a direction as a first winding portion, and the first lead is connected with the first winding portion. The second winding segment is sequentially arranged as a plurality of winding portions stacked with each other, and the second lead is connected with the last one of the winding portions.

The present invention will become more readily apparent to those ordinarily skilled in the art after reviewing the following detailed description and accompanying drawings, in which:

### BRIEF DESCRIPTION OF THE DRAWINGS

FIG. 1 schematically illustrates a sectional view of a conventional coil winding and the winding directions thereof of prior art;

FIG. 2 schematically illustrates a view showing the conventional coil winding of prior art;

FIG. 3 schematically illustrates another view showing the conventional coil winding shown in FIG. 2;

FIG. 4 schematically illustrates a sectional view of a coil winding and the winding directions thereof according to an embodiment of the present invention;

FIG. 5 schematically illustrates a view showing the coil winding of an embodiment of the present invention; and

FIG. 6 schematically illustrates another view showing the coil winding shown in FIG. 5.

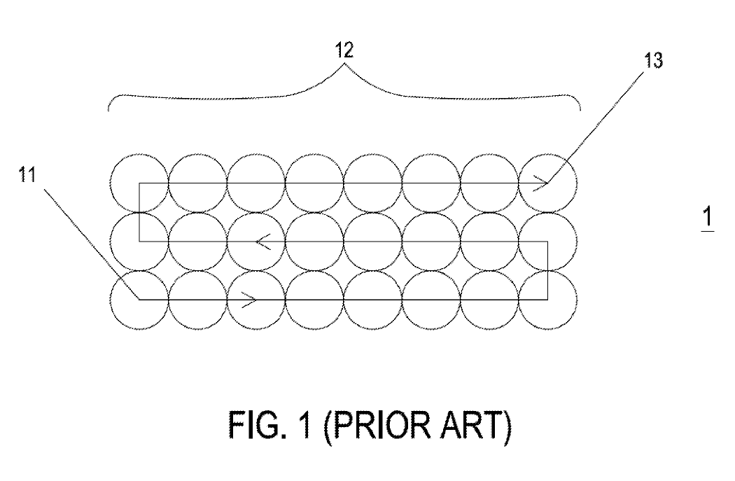

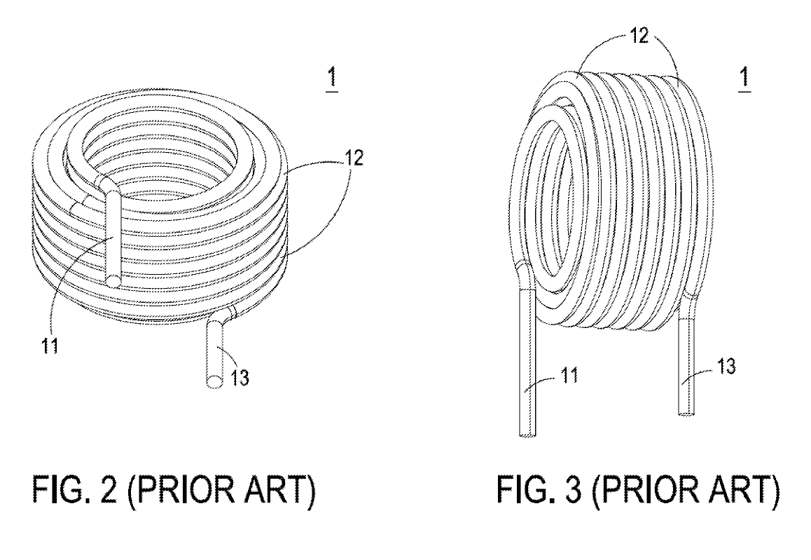

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

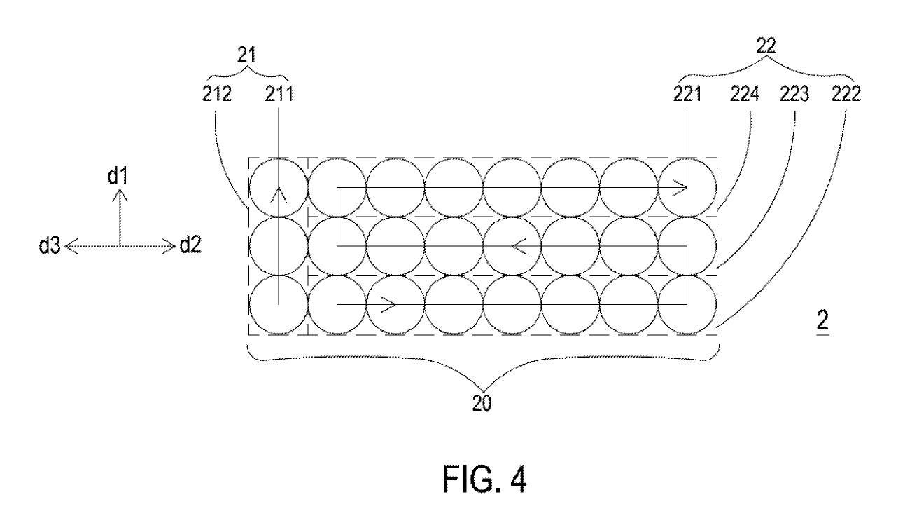

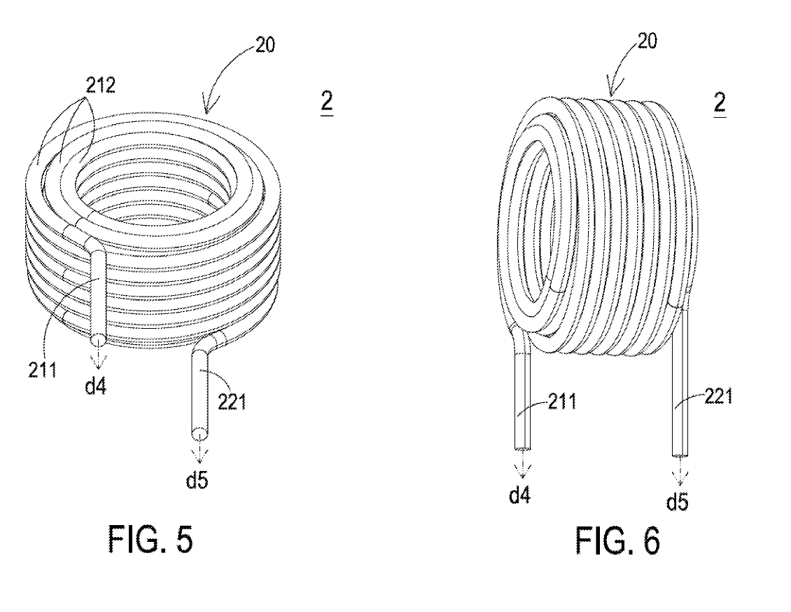

Please refer to FIG. 4, FIG. 5 and FIG. 6. FIG. 4 schematically illustrates the sectional view of a coil winding and the winding directions thereof according to an embodiment of the present invention. FIG. 5 schematically illustrates a view showing the coil winding of an embodiment of the present invention. FIG. 6 schematically illustrates another view showing the coil winding shown in FIG. 5. As shown in FIG. 4, FIG. 5 and FIG. 6, a coil winding 2 of the present invention includes a coil 20. The coil 20 has a first winding segment 21 and a second winding segment 22. The first winding segment 21 includes a first lead 211. The first winding segment 21 is stacked along a direction as a first winding portion 212 (for example, wound from an outer concentric of the coil 20 to an inner concentric of the coil 20 along an inward direction), and the first lead 211 is connected with the first winding portion 212. In other words, the first lead 211 is a part of the first segment 21, and when the first segment 21 is stacked as the first winding portion 212, the first lead 211 extends out from the first winding portion 212, but not limited herein. The second winding segment 22 includes a second lead 221. The second winding segment 22 is arranged laterally along the horizontal direction as a second winding portion 222, arranged to overlap on the second winding portion 222 laterally along the horizontal direction as a third winding portion 223, and further arranged to overlap on the third winding portion 223 laterally along the horizontal direction as a fourth winding portion 224. The second lead 221 is connected with the fourth winding portion 224. Similarly, the second lead 221 is a part of the second segment 22, and when the second segment 22 is arranged as the second winding portion 222, the third winding portion 223 and the fourth winding portion 224, the second lead 221 extends out from the fourth winding portion 224, but not limited herein. Therefore, the space where the first lead 211 is located at can be directly and sufficiently used. No extra space is occupied and hence the space can be effectively utilized.

In some embodiments, the length of the second winding segment 22 is preferably greater than the length of the first winding segment 21, and the winding height of the first winding portion 212 is preferably equal to the sum of the winding heights of the second winding portion 222, the third winding portion 223 and the fourth winding portion 224, but are not limited herein.

In an embodiment, when the coil winding 2 of the present invention substantially includes a coil 20 including a total of twenty-four turns of windings that includes three layers and eight turns per layer, the number of turns of the first winding portion 212 is three (i.e. stacked with three turns to form the first winding portion 212). The numbers of turns of the second winding portion 222, the third winding portion 223 and the fourth winding portion 224 are identical. For example, in this embodiment, the number of turns of the second winding portion 222 is seven, the number of turns of the third winding portion 223 is seven, and the number of turns of the fourth winding portion 224 is seven.

In some embodiments, if considering the first winding portion 212 as the inner side, the second winding segment 22 is substantially wound starting from the inner side to the outer side to form a layer of the second winding portion 222, then overlapping a layer by winding from the outer side to the inner side to form a layer of the third winding portion 223, and then overlapping another layer by winding from the inner side to the outer side to form a layer of the fourth winding portion 224. It is envisaged that the winding steps can be implemented in an automatic manner.

As well as the stack and the lateral/horizontal arrangement described in the embodiments mentioned above, other embodiments of the present invention are envisaged as follows. A coil winding 2 of the present invention includes a coil 20. The coil 20 has a first winding segment 21 and a second winding segment 22. The first winding segment 21 includes a first lead 211. Shown in FIG. 4, the first winding segment 21 is stacked along a first direction d1 as a first winding portion 212. The first lead 211 is connected with the first winding portion 212. In other words, the first lead 211 is a part of the first winding segment 21, and when the first segment 21 is stacked along the first direction d1 as the first winding portion 212, the first lead 211 extends out from the first winding portion 212, but not limited herein. The second winding segment 22 includes a second lead 221. The second winding segment 22 is arranged along a second direction d2 as a second winding portion 222, then moved a height of one turn of coil toward the first direction d1, then arranged along a third direction d3 as a third winding portion 223, then moved a height of one turn of coil toward the first direction d1 again, and then arranged along the second direction d2 as a fourth winding portion 224. The second lead 221 is connected with the fourth winding portion 224 and is a part of the second segment 22. When the second segment 22 is arranged as the second winding portion 222, the third winding portion 223 and the fourth winding portion 224, the second lead 221 extends out from the fourth winding portion 224, but not limited herein.

In some embodiments, the first direction d1 is perpendicular to the second direction d2, the first direction d1 is perpendicular to the third direction d3, and the second direction d2 is parallel to and opposite to the third direction d3. Referring to FIG. 5, preferably, the first lead 211 is connected with the first winding portion 212 along a fourth direction d4, and the second lead 221 is connected with the fourth winding portion 224 along a fifth direction d5. In some embodiments, the fourth direction d4 is parallel to the fifth direction d5, such that the first lead 211 is parallel to the second lead 221, but not limited herein. As can be seen, the winding spaces are sufficiently utilized by the two leads of the coil, and thus the problem of occupying more than one diameter of the coil can be avoided.

Referring to FIG. 4 and FIG. 6, the coil winding 2 of the present invention can be described as follows. A coil winding 2 of the present invention includes a coil 20. The coil 20 has a first winding segment 21 and the second winding segment 22. The first winding segment 21 includes a first lead 211. The first winding segment 21 is stacked along the vertical direction as a first winding portion 212, and the first lead 211 is connected with the first winding portion 212. The second winding segment 22 includes a second lead 221. The second winding segment 22 is sequentially arranged as a plurality of winding portions stacked overlapping with each other, and the second lead 221 is connected with the last one of the winding portions.

It should be noted that although the vertical direction described herein is for corresponding with the vertical direction shown in the figures, however it should not be limited when the coil winding 2 of the present invention is practically applied to a magnetic assembly.

By stacking the first winding segment along a vertical direction as a first winding portion and connecting the first lead with the first winding portion, the space where the first lead located at can be directly and sufficiently used, and no extra space is occupied, hence the space can be effectively utilized. Since the first lead is connected with the first winding portion of the first segment, and the second lead is connected with the last one of the winding portions of the second segment, the winding spaces are sufficiently utilized by the two leads of the coil, and thus the problem of occupying more than one diameter of the coil can be avoided.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A coil winding, comprising:
a coil, having:
a first winding segment comprising a first lead, wherein the first winding segment is arranged from an outer concentric of the coil to an inner concentric of the coil along an inward direction as a first winding portion, and the first lead is connected with the first winding portion; and
a second winding segment comprising a second lead, wherein the second winding segment is arranged along a lateral direction as a second winding portion, overlapping on the second winding portion along an opposite lateral direction as a third winding portion, and further arranged overlapping the third winding portion along the lateral direction as a fourth winding portion, and the second lead is connected with the fourth winding portion.

2. The coil winding according to claim 1, wherein a length of the second winding segment arrangement along the lateral direction is greater than a length of the first winding segment arrangement along the inward direction.

3. The coil winding according to claim 1, wherein the overlapping of the second winding, the third winding and the fourth winding is arranged from inner concentric to outer concentric along an outward direction, and wherein a length of the first winding portion arrangement along the inward direction is equal to a length of the arrangement along the outward direction of the overlapping of the second winding portion, the third winding portion and the fourth winding portion.

4. The coil winding according to claim 1, wherein a number of turns of the first winding portion is three.

5. The coil winding according to claim 4, wherein a numbers of turns of the second winding portion, the third winding portion and the fourth winding portion are identical.

6. The coil winding according to claim 5, wherein a number of turns of the second winding portion is seven, a number of turns of the third winding portion is seven, and a number of turns of the fourth winding portion is seven.

7. The coil winding according to claim 6, wherein a total number of turns of the coil is twenty-four.

8. A coil winding, comprising:
a coil, having:
a first winding segment comprising a first lead, wherein the first winding segment is stacked along a first direction as a first winding portion, and the first lead is connected with the first winding portion; and
a second winding segment comprising a second lead, wherein the second winding segment is arranged along a second direction as a second winding portion, further arranged along a third direction as a third winding portion, and further arranged along the second direction as a fourth winding portion, and wherein the second, third and fourth winding portions are stacked, and the second lead is connected with the fourth winding portion.

9. The coil winding according to claim 8, wherein a length of the stacked first winding portion is equal to a length of the stacked second, third and fourth winding portions.

10. The coil winding according to claim 8, wherein the first direction is perpendicular to the second direction.

11. The coil winding according to claim 8, wherein the first direction is perpendicular to the third direction.

12. The coil winding according to claim 8, wherein the second direction is parallel to and opposite to the third direction.

13. The coil winding according to claim 8, wherein the first lead is connected with the first winding portion and extends along a fourth direction, and the second lead is connected with the fourth winding portion and extends along a fifth direction.

14. The coil winding according to claim 13, wherein the fourth direction is parallel to the fifth direction, and the first lead extends parallel to the second lead.

15. A coil winding, comprising:
a coil, having:
a first winding segment comprising a first lead, wherein the first winding segment is stacked along a direction as a first winding portion, and the first lead is connected with the first winding portion; and
a second winding segment comprising a second lead, wherein the second winding segment is sequentially arranged as a plurality of winding portions stacked with each other, and the second lead is connected with the last one of the winding portions.
